(19) United States
(12) Patent Application Publication
(10) Pub. No.: US 2010/0054640 A1
(43) Pub. Date: Mar. 4, 2010

(54) FLUID DYNAMIC BEARINGS

(75) Inventors: Ruey-Hor Yen, Taipei City (TW); Chien-You Chen, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, TAIPEI (TW)

(21) Appl. No.: 12/544,173

(22) Filed: Aug. 19, 2009

(30) Foreign Application Priority Data
Sep. 2, 2008 (TW) TW97133565

(51) Int. Cl. F16C 32/06

(52) U.S. Cl. 384/107

(57) ABSTRACT

A fluid dynamic bearing. A shaft is fit in the sleeve and rotates with respect thereto. A lubricant is filled between the shaft and the sleeve. At least one elliptical groove is formed on either the shaft or the sleeve and between the shaft and the sleeve. When the shaft rotates with respect to the sleeve, the lubricant is filled in the elliptical groove.

### CROSS REFERENCE TO RELATED APPLICATIONS

This Application claims priority of Taiwan Patent Application No. 097133565, filed on Sep. 2, 2008, the entirety of which is incorporated by reference herein.

### BACKGROUND OF THE INVENTION

1. Field of the Invention

The invention relates to fluid dynamic bearings, and more particularly to fluid dynamic bearings with enhanced load capacity and anti-leak effects.

2. Description of the Related Art

Frictional loss, rotating noise, and reduced lifespan are conditions which relate to a ball bearing applied in a (spindle) motor of an electronic device. To overcome the aforementioned disadvantages, a fluid bearing containing a lubricant has been developed to replace the ball bearing applied in the (spindle) motor of the electronic device.

For a fluid dynamic bearing, a lubricant is filled between a stationary sleeve and a shaft, preventing collision and abrasion during rotation of the shaft. Here, the shaft is fit in the sleeve in an eccentric manner, and an outer surface of the shaft is separated from an inner surface of the sleeve. When the shaft rotates, the lubricant filled between the outer surface of the shaft and the inner surface of the sleeve is compressed to generate a dynamic pressure, sustaining rotation of the shaft. Because the lubricant provides reduced friction and absorbs vibrations, anti-shock capability of the fluid dynamic bearing can be enhanced and the lifespan thereof can be increased. Moreover, as the lubricant provides lubrication between the stationary sleeve and the shaft, noises generated by operation of the fluid dynamic bearing are reduced. In another aspect, the fluid dynamic bearing provides fewer constituent members than other bearings, such that the size of the (spindle) motor or even the electronic device can be reduced.

The lubricant filled in the fluid dynamic bearing may be a liquid or gas. Specifically, the lubricant must be sealed in the fluid dynamic bearing. In the case when there is lubricant leakage from the fluid dynamic bearing, the (outer surface of the) shaft contacts the (inner surface of the) sleeve, causing wear thereof and loss of a load pressure therein, and further resulting in deteriorated load capacity thereof.

To reduce lubricant leakage of the fluid dynamic bearing, the outer surface of the shaft or the inner surface of the sleeve is formed with a plurality of grooves. As shown in FIG. 1, for a conventional fluid dynamic bearing, the outer surface of the shaft or the inner surface of the sleeve is formed with a plurality of herringbone grooves 1. When the shaft rotates in the sleeve, the lubricant is pushed into the herringbone grooves by the outer surface of the shaft and the inner surface of the sleeve. Therefore, compared with the fluid dynamic bearing having smooth surfaces on the shaft and sleeve, the fluid dynamic bearing having the herringbone grooves 1 provides reduced lubricant leakage.

Nevertheless, when the shaft rotates, a high pressure is generated on the central area of the herringbone grooves 1 by the lubricant and distribution of the high pressure is concentrated. Additionally, due to the shape of the herringbone grooves 1, the lubricant is still pushed to the exterior of the fluid dynamic bearing via the upper and lower ends of the herringbone grooves 1.

To provide a fluid dynamic bearing with a better anti-leak effect and enhanced load capacity, adjustment of the number, angle, width, depth, and shape of the grooves thereof has been universally performed. For example, U.S. Pat. No. 5,908,247 discloses a fluid dynamic bearing with sinusoidal grooves. Moreover, U.S. Patent Publication No. 2006/0192451 discloses a fluid dynamic bearing capable of reducing leakage of a lubricant with an altered groove width.

### BRIEF SUMMARY OF THE INVENTION

A detailed description is given in the following embodiments with reference to the accompanying drawings.

An exemplary embodiment of the invention provides a fluid dynamic bearing comprising a sleeve, a shaft, and at least one elliptical groove. The shaft is fit in the sleeve and rotates with respect thereto. A lubricant is filled between the shaft and the sleeve. The elliptical groove is formed on either the shaft or the sleeve and between the shaft and the sleeve. When the shaft rotates with respect to the sleeve, the lubricant is filled in the elliptical groove.

The elliptical groove comprises a first border and a second border. The first border comprises a first elliptical curve line constructed with a first elliptical equation. The second border comprises a second elliptical curve line constructed with a second elliptical equation.

The fluid dynamic bearing further comprises at least one storage groove connecting to the middle of the elliptical groove.

Another exemplary embodiment of the invention provides a fluid dynamic bearing comprising a sleeve, a shaft, at least one elliptical groove, and at least one non-elliptical groove. The shaft is fit in the sleeve and rotates with respect thereto. A lubricant is filled between the shaft and the sleeve. The elliptical groove is formed on either the shaft or the sleeve and between the shaft and the sleeve. The non-elliptical groove connects to the elliptical groove. When the shaft rotates with respect to the sleeve, the lubricant is filled in the elliptical and non-elliptical grooves.

The elliptical groove comprises a first border and a second border. The first border comprises a first elliptical curve line constructed with a first elliptical equation. The second border comprises a second elliptical curve line constructed with a second elliptical equation.

The non-elliptical groove comprises a third border and a fourth border. The third border is connected to the first border. The fourth border is connected to the second border.

The third border parallels the fourth border.

Yet another exemplary embodiment of the invention provides a fluid dynamic bearing comprising a sleeve, a shaft, and at least one groove. The shaft is fit in the sleeve and rotates with respect thereto. A lubricant is filled between the shaft and the sleeve. The groove is formed on either the shaft or the sleeve and between the shaft and the sleeve. The groove comprises a first border and a second border. The first border comprises a plurality of first straight lines. The connecting points of the first straight lines are located on a first elliptical curve line constructed with a first elliptical equation. The second border comprises a plurality of second straight lines. The connecting points of the second straight lines are located on a second elliptical curve line constructed with a second elliptical equation.

### BRIEF DESCRIPTION OF THE DRAWINGS

The invention can be more fully understood by reading the subsequent detailed description and examples with references made to the accompanying drawings, wherein:

FIG. 1 is a schematic circumferential expanded view of an outer surface of a shaft or an inner surface of a sleeve of a conventional fluid dynamic bearing;

FIG. 2 is a partial cross section and plane view of a fluid dynamic bearing of an embodiment of the invention;

FIG. 3 is a partial circumferential expanded view of an outer surface of a shaft or an inner surface of a sleeve of a fluid dynamic bearing of an embodiment of the invention;

FIG. 4 is a table showing comparison of load capacity between a conventional fluid dynamic bearing and a fluid dynamic bearing of an embodiment of the invention;

FIG. 5 is a table showing comparison of lubricant leakage between a conventional fluid dynamic bearing and a fluid dynamic bearing of an embodiment of the invention;

FIG. 6 is a partial circumferential expanded view of an outer surface of a shaft or an inner surface of a sleeve of a fluid dynamic bearing of another embodiment of the invention;

FIG. 7 is a partial circumferential expanded view of an outer surface of a shaft or an inner surface of a sleeve of a fluid dynamic bearing of yet another embodiment of the invention;

FIG. 8 is a partial circumferential expanded view of an outer surface of a shaft or an inner surface of a sleeve of a fluid dynamic bearing of still another embodiment of the invention;

FIG. 9 is a partial circumferential expanded view of an outer surface of a shaft or an inner surface of a sleeve of a fluid dynamic bearing of still another embodiment of the invention; and

FIG. 10 is a partial circumferential expanded view of an outer surface of a shaft or an inner surface of a sleeve of a fluid dynamic bearing of still another embodiment of the invention.

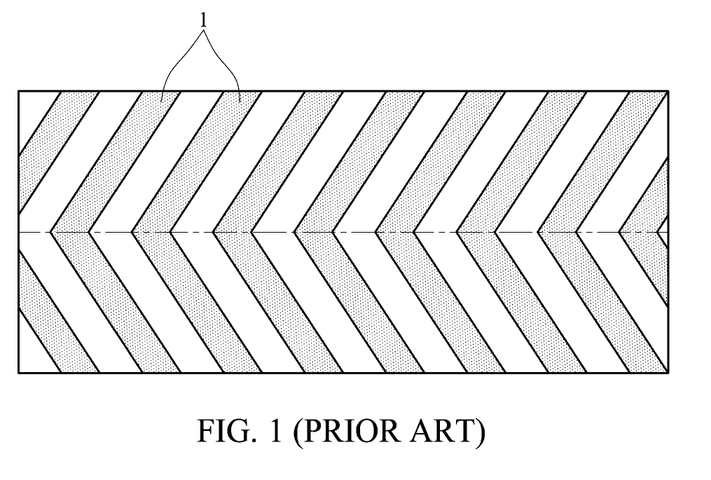

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present fluid dynamic bearings can be applied in (spindle) motors of electronic devices to overcome disadvantages, such as lubricant leakage and insufficient load capacity, found in conventional fluid dynamic bearings.

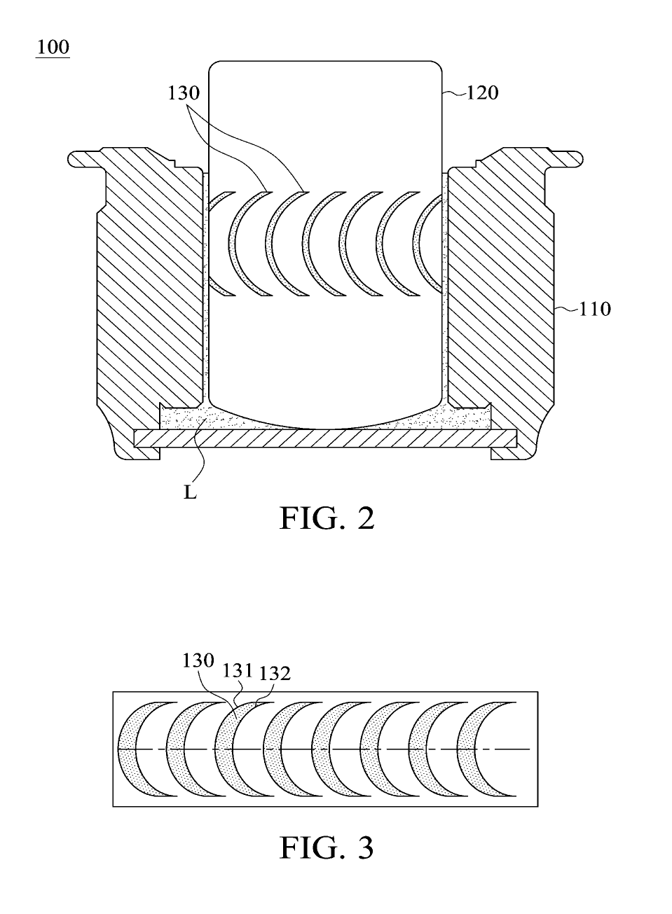

Referring to FIG. 2, a fluid dynamic bearing 100 comprises a sleeve 110, a shaft 120, and a plurality of elliptical grooves 130.

The shaft 120 is fit in the sleeve 110 and rotates with respect thereto. Specifically, the shaft 120 is fit in the sleeve 110 in an eccentric manner, and an outer surface of the shaft 120 is separated from an inner surface of the sleeve 110. Moreover, a lubricant L (such as lubrication oil) is filled between the shaft 120 and the sleeve 110.

The elliptical grooves 130 are formed on either the shaft 120 or the sleeve 110 and between the shaft 120 and the sleeve 110. Specifically, the elliptical grooves 130 may be formed on the outer surface of the shaft 120 or the inner surface of the sleeve 110. For example, as illustrated in FIG. 2, the elliptical grooves 130 are formed on the outer surface of the shaft 120.

In an embodiment, as shown in FIG. 3, each elliptical groove 130 comprises a first border 131 and a second border 132. The first border 131 comprises a first elliptical curve line constructed with a first elliptical equation. The second border 132 comprises a second elliptical curve line constructed with a second elliptical equation. Here, the first and second elliptical equations may be expressed by the following equation:

$$\frac{{( x - {x}_{0} )}^{2}}{{L}_{a}^{2}} + \frac{{( y - {y}_{0} )}^{2}}{{L}_{b}^{2}} = 1 ,$$

wherein Lₐ and L_{b} respectively denote the axial length of an ellipse in x and y directions, and x₀ and y₀ respectively denote the positions of axle centers of the ellipse.

Moreover, according to practical design requirements of the fluid dynamic bearing, the first and second elliptical equations may be the same or different. Namely, the curvature variation of the first elliptical curve line may be the same as or different from that of the second elliptical curve line.

Accordingly, when the shaft 120 rotates with respect to the sleeve 110, the lubricant L is compressed between the outer surface of the shaft 120 and the inner surface of the sleeve 110, generating a dynamic pressure. At this point, the lubricant L is filled in or pushed into the elliptical grooves 130. Here, due to the curvature variation provided by the elliptical grooves 130, the pressure distribution of the lubricant L filled in the elliptical grooves 130 is greater and more uniform than that of the lubricant filled in the conventional herringbone grooves. Thus, the fluid dynamic bearing 100 can provide greater load capacity than the conventional fluid dynamic bearings. Additionally, as the first border 131 and second border 132 of each elliptical groove 130 are designed with elliptical curve lines, the lubricant L filled in each elliptical groove 130 does not easily leak out of the fluid dynamic bearing 100 via two ends thereof. Thus, the fluid dynamic bearing 100 can provide enhanced anti-leak performance. Specifically, according to verification of experiment measurements and numerical simulations, a large high-pressure area is provided in the central portion of each elliptical groove 130 and low-pressure areas are provided in the edges thereof. Accordingly, by integrating pressure, the fluid dynamic bearing 100 can provide enhanced load capacity and reduced leakage of the lubricant.

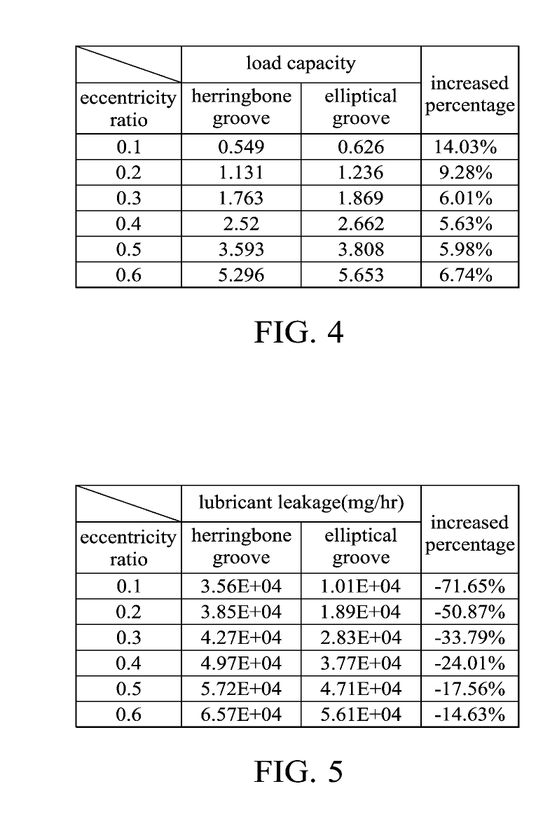

FIG. 4 is a table showing comparison of load capacity between a conventional fluid dynamic bearing and the present fluid dynamic bearing 100 under an optimal parametric condition. Here, the conventional fluid dynamic bearing is provided with isogonal herringbone grooves and the eccentricity ratio denotes the ratio of the distance between the centers of the shaft and sleeve to the difference between the radiuses of the shaft and sleeve. According to the comparison shown in FIG. 4, for all eccentricity ratios, the fluid dynamic bearing 100 with the elliptical grooves 130 provides greater load capacity than the conventional fluid dynamic bearing with the isogonal herringbone grooves.

FIG. 5 is a table showing comparison of lubricant leakage between a conventional fluid dynamic bearing and the present fluid dynamic bearing 100 under an optimal parametric condition. Here, the conventional fluid dynamic bearing is provided with isogonal herringbone grooves, and the comparison of lubricant leakage is conducted with no anti-leak means provided by two ends of each of the conventional fluid dynamic bearing and present fluid dynamic bearing 100. According to the comparison shown in FIG. 5, for all eccentricity ratios, the fluid dynamic bearing 100 with the elliptical grooves 130 provides less lubricant leakage than the conventional fluid dynamic bearing with the isogonal herringbone grooves. Specifically, as the pressure on the central area of each isogonal herringbone groove exceeds that of each elliptical groove, the amount of the lubricant pushed out of the isogonal herringbone groove exceeds that pushed out of the elliptical groove.

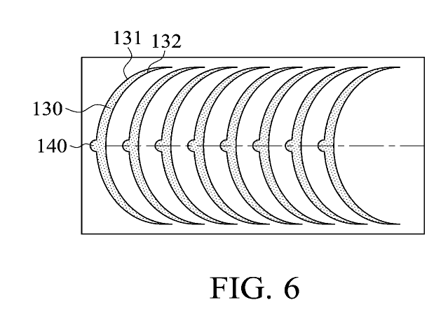

In another embodiment, as shown in FIG. 6, the fluid dynamic bearing further comprises a plurality of storage grooves 140 receiving the lubricant. Here, each storage groove 140 connects to the middle of each elliptical groove 130. Additionally, the storage grooves 140 may have semicircular, triangular, and rectangular profiles.

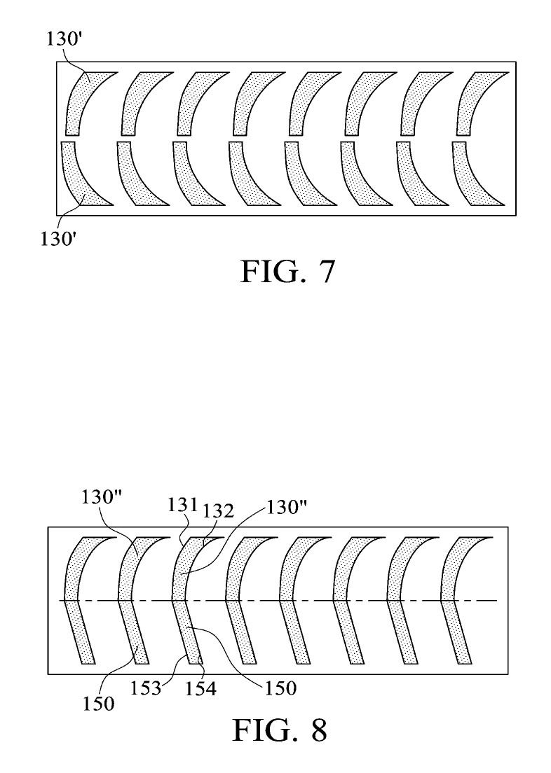

In yet another embodiment, as shown in FIG. 7, the elliptical grooves 130′ are alternately formed on the outer surface of the shaft 120 or the inner surface of the sleeve 110. Specifically, every two opposing elliptical grooves 130′ are separated from each other by a predetermined distance on the central portion of the outer surface of the shaft 120 or the inner surface of the sleeve 110.

In still another embodiment, as shown in FIG. 8, the fluid dynamic bearing comprises a plurality of elliptical grooves 130″ and a plurality of non-elliptical grooves 150. The elliptical grooves 130″ and non-elliptical grooves 150 are formed on the outer surface of the shaft or the inner surface of the sleeve. Specifically, the non-elliptical grooves 150 connect to the elliptical grooves 130″, respectively.

Similarly, each elliptical groove 130″ comprises a first border 131 and a second border 132. The first border 131 comprises a first elliptical curve line constructed with a first elliptical equation. The second border 132 comprises a second elliptical curve line constructed with a second elliptical equation.

Each non-elliptical groove 150 comprises a third border 153 and a fourth border 154. The third border 153 is connected to the first border 131 of each elliptical groove 130″ and the fourth border 154 is connected to the second border 132 of each elliptical groove 130″. In this embodiment, as shown in FIG. 8, the third border 153 parallels the fourth border 154 and the third border 153 and fourth border 154 are straight lines.

Moreover, according to practical design requirements of the fluid dynamic bearing, the first border 131 and second border 132 may be the same or different elliptical curve lines. Additionally, the third border 153 and fourth border 154 may be straight lines with the same or different slopes, or the third border 153 and fourth border 154 may be the same or different curve lines.

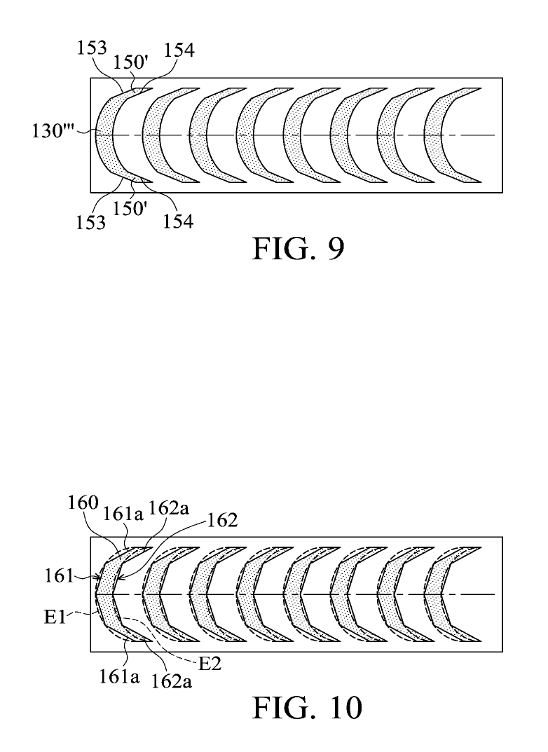

In still another embodiment, as shown in FIG. 9, the non-elliptical grooves 150′ connect to two ends of the elliptical grooves 130′″, respectively. Here, the third border 153 and fourth border 154 of each non-elliptical groove 150′ are straight lines.

In still another embodiment, as shown in FIG. 10, the fluid dynamic bearing comprises a plurality of grooves 160 formed on the outer surface of the shaft or the inner surface of the sleeve. Specifically, each groove 160 comprises a first border 161 and a second border 162. The first border 161 comprises a plurality of first straight lines 161a. Here, the connecting points of the first straight lines 161a are located on a first elliptical curve line E1 constructed with a first elliptical equation. The second border 162 comprises a plurality of second straight lines 162a. Here, the connecting points of the second straight lines 162a are located on a second elliptical curve line E2 constructed with a second elliptical equation.

Moreover, according to practical design requirements of the fluid dynamic bearing, the first and second elliptical equations may be the same or different. Namely, the curvature variation of the first elliptical curve line E1 may be the same as or different from that of the second elliptical curve line E2.

In conclusion, the disclosed fluid dynamic bearings can change the pressure distribution of the lubricants therein with the curvature variation of the grooves. When the lubricants are compressed between the shafts and the sleeves, the fluid dynamic bearings can provide massive dynamic pressure, thus providing outstanding load capacity, and further reducing leakage of the lubricants.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid dynamic bearing, comprising:
a sleeve;
a shaft fit in the sleeve and rotating with respect thereto, wherein a lubricant is filled between the shaft and the sleeve; and
at least one elliptical groove formed on either the shaft or the sleeve and between the shaft and the sleeve, wherein, when the shaft rotates with respect to the sleeve, the lubricant is filled in the elliptical groove.

2. The fluid dynamic bearing as claimed in claim 1, wherein the elliptical groove comprises a first border and a second border, the first border comprises a first elliptical curve line constructed with a first elliptical equation, and the second border comprises a second elliptical curve line constructed with a second elliptical equation.

3. The fluid dynamic bearing as claimed in claim 1, further comprising at least one storage groove connecting to the middle of the elliptical groove.

4. A fluid dynamic bearing, comprising:
a sleeve;
a shaft fit in the sleeve and rotating with respect thereto, wherein a lubricant is filled between the shaft and the sleeve;
at least one elliptical groove formed on either the shaft or the sleeve and between the shaft and the sleeve; and
at least one non-elliptical groove connecting to the elliptical groove, wherein, when the shaft rotates with respect to the sleeve, the lubricant is filled in the elliptical and non-elliptical grooves.

5. The fluid dynamic bearing as claimed in claim 4, wherein the elliptical groove comprises a first border and a second border, the first border comprises a first elliptical curve line constructed with a first elliptical equation, and the second border comprises a second elliptical curve line constructed with a second elliptical equation.

6. The fluid dynamic bearing as claimed in claim 5, wherein the non-elliptical groove comprises a third border and a fourth border, the third border is connected to the first border, and the fourth border is connected to the second border.

7. The fluid dynamic bearing as claimed in claim 6, wherein the third border parallels the fourth border.

8. A fluid dynamic bearing, comprising:
a sleeve;
a shaft fit in the sleeve and rotating with respect thereto, wherein a lubricant is filled between the shaft and the sleeve; and
at least one groove formed on either the shaft or the sleeve and between the shaft and the sleeve, wherein the groove comprises a first border and a second border, the first border comprises a plurality of first straight lines, the connecting points of the first straight lines are located on a first elliptical curve line constructed with a first elliptical equation, the second border comprises a plurality of second straight lines, and the connecting points of the second straight lines are located on a second elliptical curve line constructed with a second elliptical equation.
